(19) United States
(12) Patent Application Publication
(10) Pub. No.: US 2013/0271311 A1
(43) Pub. Date: Oct. 17, 2013

(54) RECEIVING AND PROCESSING DEVICE, RECEIVING AND PROCESSING METHOD, AND RECEIVING AND PROCESSING PROGRAM

(71) Applicant: HONDA ELESYS CO., LTD., Yokohama-shi (JP)

(72) Inventors: Itaru IZUMI, Yokohama-shi (JP); Takeshi Kambe, Yokohama-skhi (JP)

(21) Appl. No.: 13/861,022

(22) Filed: Apr. 11, 2013

(30) Foreign Application Priority Data
Apr. 12, 2012 (JP) 2012-091128

(51) Int. Cl. H04B 1/16; G01S 13/06

(52) U.S. Cl. CPC H04B 1/16; G01S 13/06
USPC 342/146; 455/273

(57) ABSTRACT

A receiving and processing device includes an antenna extension unit configured to perform a process of additionally arranging data pieces of two or more continuous receiving antennas in a receiving antenna array in which the plurality of receiving antennas are arranged at regular intervals, a process of inverting phases of data pieces of the additionally-arranged two or more receiving antennas, a process of rearranging the data pieces of the phase-inverted two or more receiving antennas so as to invert the arrangement of the data pieces, a process of rotating the phases of the data pieces of the rearranged two or more receiving antennas, and a process of connecting the data pieces of the phase-rotated two or more receiving antennas to the data pieces of the plurality of receiving antennas.

### CROSS-REFERENCE TO RELATED APPLICATIONS

Priority is claimed on Japanese Patent Application No. 2012-091128, filed Apr. 12, 2012, the contents of which are entirely incorporated herein by reference.

### BACKGROUND OF THE INVENTION

1. Field of the Invention

The present invention relates to a receiving and processing device, a receiving and processing method, and a receiving and processing program.

2. Description of Related Art

Recently, for the purpose of improvement of convenience or safety in vehicles such as automobiles, an on-board radar apparatus using a millimeter wave radar as a detection device has been mounted on vehicles more and more.

Particularly, an FM-CW (Frequency-Modulated Continuous Wave) system capable of simultaneously acquiring a distance and a relative velocity to a target object (object) is generally used as a detection technique in the longitudinal direction. Techniques such as detection of an orientation of an object using DBF (Digital beam Forming) or separation of objects using a high-resolution algorithm are generally used as a detection technique in the transverse direction.

Here, the on-board radar apparatus is mounted, for example, on a front part of a vehicle so as to transmit radio waves (transmitted waves) forward from the vehicle and to detect information on an object present in the front of the vehicle.

In this case, the longitudinal direction means the same direction as a forward direction (traveling direction) of a vehicle. In this case, the transverse direction means a direction of orientation (orientation angle) about the forward direction (traveling direction) of a vehicle.

In an on-board radar apparatus using the FM-CW system, beat signals are generated by transmitting a modulated wave from a transmitting antenna, receiving a reflected wave from a reflecting object (target object) by the use of an antenna array in which receiving antennas are arranged, and mixing the received signals with the transmitted signal by the use of a mixer. Thereafter, frequency components relevant to the reflecting object are extracted by receiving the beat signals as digital signals through the use of an A/D (Analog-to-Digital) converter and processing the digital signals by FFT (Fast Fourier Transform). The relative velocity and the distance to the target object are calculated by a combination of the frequency components extracted from the ascending section and the descending section in modulation frequency.

In the on-board radar apparatus, the orientation of the target object is calculated by detecting an orientation using signal processes such as a DBF or a high-resolution algorithm on the frequency components relevant to the reflecting object.

Here, in order to improve the resolution in the transverse direction, for example, it is a general practice to physically increase the number of antennas in a receiving antenna array or to increase the number of channels (Ch) by interpolating receiving elements.

For example, in a signal processing device described in JP-A-2010-71865, a combined beat signal having the same phase as a beat signal acquired through the use of a virtual antenna, which is disposed between a pair of antennas, can be acquired by combining the beat signals to generate the combined beat signal and an orientation angle detection range in which phase replication does not occur with the antenna interval set to a certain degree can be broadened by detecting an orientation angle of a target object based on any one of the beat signals and the combined beat signal.

For example, in a moving target detecting device described in JP-A-2006-258530, some receiving antennas out of multiple receiving antennas are arranged at an interval different from the interval of the other receiving antennas, the some receiving antennas share a receiving unit with the other receiving antennas using a selector, and a vehicle, a ship, or the like is detected.

### SUMMARY OF THE INVENTION

However, for example, in the configuration in which the resolution is enhanced by physically increasing the number of antennas in a receiving antenna array, there are many problems to be solved for realization such as a problem in that a lot of expensive components need to be used.

For example, in the configuration in which the number of receiving elements is increased by linearly interpolating the receiving elements of an existing receiving antenna array, there is a problem in that the enhancement of the resolution due to an increase in the number of elements is not achieved. In addition, there is a problem in that when multiple components are provided, discordance due to an increase in the number of elements occurs and thus the performance is deteriorated more than the performance before extension.

The present invention is made in consideration of the above-mentioned circumstances and an object thereof is to provide a receiving and processing device, a receiving and processing method, and a receiving and processing program capable of effectively enhancing a resolution for signals received through the use of a receiving antenna array.

(1) According to an aspect of the present invention, a receiving and processing device, which processes data pieces of a plurality of receiving antennas acquired based on signals received by the receiving antennas constituting a receiving antenna array in which the plurality of receiving antennas are arranged at regular intervals, is provided including an antenna extension unit configured to perform: a process of arranging the data pieces of two or more continuous receiving antennas of the plurality of receiving antennas so as to be added to the data pieces of the plurality of receiving antennas in such a manner that a position of the receiving antenna at one end of the two or more receiving antennas is located at a position of the receiving antenna at the opposite end of the plurality of receiving antennas; a process of inverting phases of data pieces of the additionally-arranged two or more receiving antennas; a process of rearranging the data pieces of the phase-inverted two or more receiving antennas so as to invert the arrangement of the data pieces; a process of rotating the phases of the data pieces of the rearranged two or more receiving antennas so that the phases of two data pieces at the position of the receiving antenna at the opposite end of the plurality of receiving antennas match each other; and a process of connecting the data pieces of the phase-rotated two or more receiving antennas to the data pieces of the plurality of receiving antennas by employing the data piece of the corresponding receiving antenna at the position of the receiving antenna at the opposite end of the plurality of receiving antennas.

(2) According to another aspect of the present invention, a receiving and processing device, which processes data pieces of a plurality of receiving antennas acquired based on signals received by the receiving antennas constituting a receiving antenna array in which the plurality of receiving antennas are arranged at regular intervals, is provided including an antenna extension unit configured to perform: a process of arranging the data pieces of two or more continuous receiving antennas of the plurality of receiving antennas so as to be added to the data pieces of the plurality of receiving antennas in such a manner that a position of the receiving antenna at one end of the two or more receiving antennas is located at a position of the receiving antenna at the opposite end of the plurality of receiving antennas; a process of rotating the phases of the data pieces of the additionally-arranged two or more receiving antennas so that the phases of two data pieces at the position of the receiving antenna at the opposite end of the plurality of receiving antennas match each other; and a process of connecting the data pieces of the phase-rotated two or more receiving antennas to the data pieces of the plurality of receiving antennas by employing the data piece of the corresponding receiving antenna at the position of the receiving antenna at the opposite end of the plurality of receiving antennas.

(3) In the receiving and processing device according to (1) or (2), the two or more continuous receiving antennas of the plurality of receiving antennas may include all the plurality of receiving antennas.

(4) In the receiving and processing device according to any one of (1) to (3), the receiving and processing device may be mounted on an on-board radar apparatus, a received wave arriving by causing an object to reflect a transmitted wave may be received through the use of the receiving antenna array, the data pieces of the receiving antennas may be complex data of frequency components, and information on the position of the object may be detected using the data pieces acquired by the antenna extension unit.

(5) According to another aspect of the present invention, a receiving and processing method, which handles data pieces of a plurality of receiving antennas acquired based on signals received by the receiving antennas constituting a receiving antenna array in which the plurality of receiving antennas are arranged at regular intervals, is provided including the steps of: arranging the data pieces of two or more continuous receiving antennas of the plurality of receiving antennas so as to be added to the data pieces of the plurality of receiving antennas in such a manner that a position of the receiving antenna at one end of the two or more receiving antennas is located at a position of the receiving antenna at the opposite end of the plurality of receiving antennas; inverting phases of data pieces of the additionally-arranged two or more receiving antennas; rearranging the data pieces of the phase-inverted two or more receiving antennas so as to invert the arrangement of the data pieces; rotating the phases of the data pieces of the rearranged two or more receiving antennas so that the phases of two data pieces at the position of the receiving antenna at the opposite end of the plurality of receiving antennas match each other; and connecting the data pieces of the phase-rotated two or more receiving antennas to the data pieces of the plurality of receiving antennas by employing the data piece of the corresponding receiving antenna at the position of the receiving antenna at the opposite end of the plurality of receiving antennas.

(6) According to another aspect of the present invention, a receiving and processing method, which handles data pieces of a plurality of receiving antennas acquired based on signals received by the receiving antennas constituting a receiving antenna array in which the plurality of receiving antennas are arranged at regular intervals, is provided including the steps of: arranging the data pieces of two or more continuous receiving antennas of the plurality of receiving antennas so as to be added to the data pieces of the plurality of receiving antennas in such a manner that a position of the receiving antenna at one end of the two or more receiving antennas is located at a position of the receiving antenna at the opposite end of the plurality of receiving antennas; rotating the phases of the data pieces of the additionally-arranged two or more receiving antennas so that the phases of two data pieces at the position of the receiving antenna at the opposite end of the plurality of receiving antennas match each other; and connecting the data pieces of the phase-rotated two or more receiving antennas to the data pieces of the plurality of receiving antennas by employing the data piece of the corresponding receiving antenna at the position of the receiving antenna at the opposite end of the plurality of receiving antennas.

(7) According to another aspect of the present invention, a receiving and processing program, which processes data pieces of a plurality of receiving antennas acquired based on signals received by the receiving antennas constituting a receiving antenna array in which the plurality of receiving antennas are arranged at regular intervals, is provided causing a computer to perform the sequences of: arranging the data pieces of two or more continuous receiving antennas of the plurality of receiving antennas so as to be added to the data pieces of the plurality of receiving antennas in such a manner that a position of the receiving antenna at one end of the two or more receiving antennas is located at a position of the receiving antenna at the opposite end of the plurality of receiving antennas; inverting phases of data pieces of the additionally-arranged two or more receiving antennas; rearranging the data pieces of the phase-inverted two or more receiving antennas so as to invert the arrangement of the data pieces; rotating the phases of the data pieces of the rearranged two or more receiving antennas so that the phases of two data pieces at the position of the receiving antenna at the opposite end of the plurality of receiving antennas match each other; and connecting the data pieces of the phase-rotated two or more receiving antennas to the data pieces of the plurality of receiving antennas by employing the data piece of the corresponding receiving antenna at the position of the receiving antenna at the opposite end of the plurality of receiving antennas.

(8) According to another aspect of the present invention, a receiving and processing program, which processes data pieces of a plurality of receiving antennas acquired based on signals received by the receiving antennas constituting a receiving antenna array in which the plurality of receiving antennas are arranged at regular intervals, is provided causing a computer to perform the sequences of: arranging the data pieces of two or more continuous receiving antennas of the plurality of receiving antennas so as to be added to the data pieces of the plurality of receiving antennas in such a manner that a position of the receiving antenna at one end of the two or more receiving antennas is located at a position of the receiving antenna at the opposite end of the plurality of receiving antennas; rotating the phases of the data pieces of the additionally-arranged two or more receiving antennas so that the phases of two data pieces at the position of the receiving antenna at the opposite end of the plurality of receiving antennas match each other; and connecting the data pieces of the phase-rotated two or more receiving antennas to the data pieces of the plurality of receiving antennas by employing the data piece of the corresponding receiving antenna at the position of the receiving antenna at the opposite end of the plurality of receiving antennas.

As described above, according to the aspects of the present invention, it is possible to provide a receiving and processing device, a receiving and processing method, and a receiving and processing program capable of effectively enhancing a resolution for signals received through the use of a receiving antenna array.

### BRIEF DESCRIPTION OF THE DRAWINGS

FIG. 1 is a block diagram illustrating a configuration of an on-board radar apparatus according to an embodiment of the present invention.

FIG. 2 is a block diagram illustrating an example of an arrangement of receiving antennas constituting a receiving antenna array according to an embodiment of the present invention.

FIG. 3 is a diagram illustrating an image of a sequence of processes which is performed by an antenna extension unit according to a first embodiment of the present invention.

FIG. 4 is a flowchart illustrating an example of the sequence of processes which is performed by the antenna extension unit according to the first embodiment of the present invention.

Part (A) of FIG. 5 is a diagram illustrating an example of the result of a simulation of a DBF spectrum when the number of elements does not increase, and Part (B) of FIG. 5 is a diagram illustrating an example of the result of a simulation of a DBF spectrum when the number of elements increases.

FIG. 6 is a diagram illustrating an image of a sequence of processes which is performed by an antenna extension unit according to a second embodiment of the present invention.

### DETAILED DESCRIPTION OF THE INVENTION

### First Embodiment

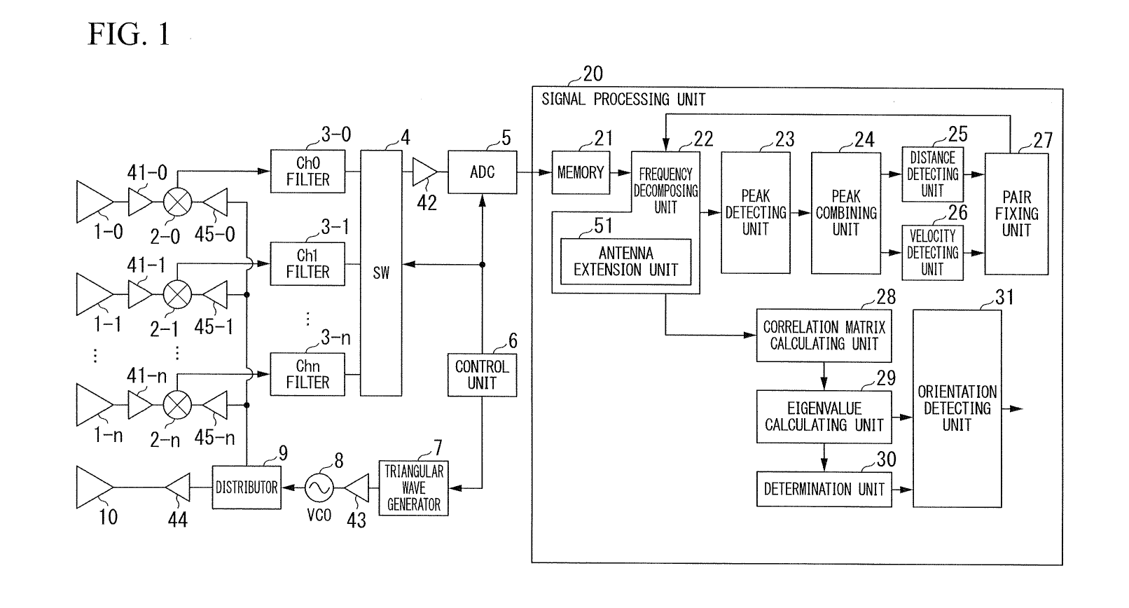

FIG. 1 is a block diagram illustrating a configuration of an on-board radar apparatus according to an embodiment of the present invention.

In this embodiment, an electronic scanning radar apparatus (an FM-CW type millimeter wave radar apparatus) will be described as an example of the on-board radar apparatus.

The on-board radar apparatus according to this embodiment is disposed in the front part of a vehicle so as to transmit a radio wave (transmitted wave) forward from the vehicle (for example, an automobile in this embodiment) and to detect information on an object (a target) present in the front of the vehicle.

The radar apparatus according to this embodiment includes (n+1) receiving antennas (receiving elements) 1-0 to 1-n, (n+1) mixers 2-0 to 2-n, (n+1) filters 3-0 to 3-n, a switch (SW) 4, an A/D converter (ADC) 5, a control unit 6, a triangular wave generator 7, a voltage-controlled oscillator (VCO) 8, a distributor 9, a transmitting antenna 10, and a signal processing unit 20.

Here, (n+1) is an integer greater than or equal to two.

The radar apparatus according to this embodiment further includes (n+1) amplifiers 41-0 to 41-n, an amplifier 42, an amplifier 43, an amplifier 44, and (n+1) amplifiers 45-0 to 45-n.

Here, the on-board radar apparatus according to this embodiment includes a receiving system of (n+1) channels (Ch) constituting a receiving antenna array. For the channels, the receiving antennas 1-0 to 1-n, the amplifiers 41-0 to 41-n, the mixers 2-0 to 2-n, the filters 3-0 to 3-n, and the amplifiers 45-0 to 45-n.

In this embodiment, an example of n=4 will be described.

The signal processing unit 20 includes a memory 21, a frequency decomposing unit 22, a peak detecting unit 23, a peak combining unit 24, a distance detecting unit 25, a velocity detecting unit 26, a pair fixing unit 27, a correlation matrix calculating unit 28, an eigenvalue calculating unit 29, a determination unit 30, and an orientation detecting unit 31.

The frequency decomposing unit 22 includes an antenna extension unit 51.

An example of schematic operations performed by the on-board radar apparatus according to this embodiment will be described below.

The triangular wave generator 7 generates a triangular wave signal and outputs the generated triangular wave signal to the amplifier 43 under the control of the control unit 6.

The amplifier 43 amplifies the triangular wave signal input from the triangular wave generator 7 and outputs the amplified triangular wave signal to the VCO 8.

The VCO 8 outputs a signal, which is obtained by frequency-modulating the triangular wave signal, as a transmission signal to the distributor 9 based on the triangular wave signal input from the amplifier 43.

The distributor 9 distributes the transmission signal input from the VCO 8 into two signals, outputs one distributed signal to the amplifier 44, and outputs the other distributed signal to the amplifiers 45-0 to 45-n.

The amplifier 44 amplifies the signal input from the distributor 9 and outputs the amplified signal to the transmitting antenna 10.

The transmitting antenna 10 transmits the signal input from the amplifier 44 as a transmitted wave in a wireless manner.

The transmitted wave is reflected by an object.

The receiving antennas 1-0 to 1-n receive a reflected wave (that is, a received wave) arriving by causing the object to reflect the transmitted wave transmitted from the transmitting antenna 10 and output the received wave to the amplifiers 41-0 to 41-n, respectively.

The amplifiers 41-0 to 41-n amplify the received waves input from the receiving antennas 1-0 to 1-n and output the amplified received waves to the mixers 2-0 to 2-n, respectively.

The amplifiers 45-0 to 45-n amplify the signal (the distributed signal of the transmission signal) input from the distributor 9 and outputs the amplified signals to the mixers 2-0 to 2-n, respectively.

The mixers 2-0 to 2-n mix the signals of the received waves input from the amplifiers 41-0 to 41-n with the signals (the signal of the transmitted wave transmitted from the transmitting antenna 10) input from the amplifiers 45-0 to 45-n, respectively, to generate beat signals corresponding to frequency differences therebetween, and output the generated beat signals to the filters 3-0 to 3-n, respectively.

The filters 3-0 to 3-n band-limit the beat signals (the beat signals of channels 0 to n corresponding to the receiving antennas 1-0 to 1-n) input from the mixers 2-0 to 2-n, respectively, and outputs the band-limited beat signals to the switch 4.

The switch 4 sequentially switches and outputs the beat signals input from the filters 3-0 to 3-n to the amplifier 42 in response to a sampling signal input from the control unit 6.

The amplifier 42 amplifies the beat signals input from the switch 4 and outputs the amplified beat signals to the A/D converter 5.

The A/D converter 5 A/D converts the beat signals (the beat signals of channels 0 to n corresponding to the receiving antennas 1-0 to 1-n), which are input from the switch 4 in synchronization with the sampling signal, in response to the sampling signal input from the control unit 6 to convert analog signals into digital signals in synchronization with the sampling signal, and sequentially the resultant digital signals in a waveform storage area of the memory 21 of the signal processing unit 20.

The control unit 6 is constructed, for example, using a microcomputer or the like.

The control unit 6 controls the overall units of the on-board radar apparatus based on a control program stored in a ROM (Read Only Memory) not shown.

In a specific example, the control unit 6 controls a process of causing the triangular wave generator 7 to a triangular wave signal, generates a predetermined sampling signal, and outputs the generated sampling signal to the switch 4 and the A/D converter 5.

An example of schematic operations performed by the signal processing unit 20 will be described below.

The memory 21 stores the digital signals (beat signals) acquired by the A/D converter 5 in the waveform storage area thereof in correlation with the antennas 1-0 to 1-n. The digital signals are time-series data of a rising portion and a descending portion.

For example, when 256 values are sampled in each of the rising portion and the descending portion, 2×256×number of antennas data pieces are stored in the waveform storage area of the memory 21.

The frequency decomposing unit 22 transforms the beat signals corresponding to the channels 0 to n (the receiving antennas 1-0 to 1-n) to frequency components with a predetermined resolution by a frequency transform (such as a Fourier transform or DTC, a Hadamard transform, or a wavelet transform), and outputs frequency points representing beat frequencies obtained as a result and complex data of the beat frequencies to the peak detecting unit 23 and the correlation matrix calculating unit 28.

In this embodiment, the frequency decomposing unit 22 is provided with the antenna extension unit 51, and the frequency decomposing unit 22 may output frequency points representing beat frequencies obtained using the function of the antenna extension unit 51 and complex data of the beat frequencies to the peak detecting unit 23 and the correlation matrix calculating unit 28, instead of outputting the frequency points obtained as described above without using the function of the antenna extension unit 51 and the complex data of the beat frequencies to the peak detecting unit 23 and the correlation matrix calculating unit 28.

For example, the frequency decomposing unit 22 may be configured to always output the result using the function of the antenna extension unit 51. Alternatively, for example, the frequency decomposing unit 22 may be configured to switch and output the result not using the function of the antenna extension unit 51 and the result using the function of the antenna extension unit 51 depending on an instruction from a user, a predetermined condition, or the like.

The function of the antenna extension unit 51 will be described later.

The processes performed by the frequency decomposing unit 22 will be specifically described below.

In the on-board radar apparatus according to this embodiment, a reception signal which is the reflected wave from an object is received with a delay in the time delay direction (for example, in the right direction in a graph not shown) with respect to the transmission signal in proportion to the distance between the on-board radar apparatus according to this embodiment and the object. The reception signal varies in the frequency direction (for example, in the vertical direction in a graph not shown) with respect to the transmission signal in proportion to the relative velocity of the object to the on-board radar apparatus according to this embodiment.

At this time, when the beat signals are frequency-transformed, a single peak value appears in each of the ascending portion (ascending region) and the descending portion (descending region) of a triangular wave for a single object.

The frequency decomposing unit 22 frequency-transforms sampled data of the beat signals stored in the memory 21 in each of the ascending portion (ascent) and the descending portion (descent) of a triangular wave at discrete times through the use of frequency decomposition (for example, Fourier transform). That is, the frequency decomposing unit 22 frequency-decomposes the beat signals to beat frequencies having a predetermined frequency bandwidth, and calculates complex data based on the beat signals decomposed for each beat frequency.

As a result, a signal level for each beat frequency to which the beat signals are frequency-decomposed is obtained in each of the ascending portion and the descending portion of a triangular wave. The result is output to the peak detecting unit 23 and the correlation matrix calculating unit 28.

For example, when 256 data pieces are sampled in each of the ascending portion and the descending portion of a triangular wave for each of the receiving antennas 1-0 to 1-n, 128 complex data pieces (2×128×number of antennas) are obtained in each of the descending portion and the descending portion of a triangular wave.

The complex data pieces for each of the receiving antennas 1-0 to 1-n have a phase difference depending on a predetermined angle 0, and the absolute values (for example, received intensity or amplitude) of the complex data pieces in a complex plane are equal to each other.

The predetermined angle 0 will be described below.

An example where the receiving antennas 1-0 to 1-n are arranged in an array shape will be considered.

A wave (incident wave, that is, a reflected wave obtained by causing an object to reflect the transmitted wave transmitted from the transmitting antenna 10) arriving from an object is input on the receiving antennas 1-0 to 1-n from the direction of angle 0 about the axis perpendicular to a plane on which the antennas are arranged.

At this time, the arriving wave is received at the same angle 0 by the receiving antennas 1-0 to 1-n.

A phase difference (a value proportional to a path difference “d·sin θ”) calculated using the same angle θ and the interval d between two neighboring receiving antennas 1-0 to 1-n is caused between the two neighboring antennas 1-0 to 1-n.

By detecting an orientation using the phase difference through the use of a signal process such as a DBF or a high-resolution algorithm, it is possible to detect the orientation (angle θ) of the object.

The peak detecting unit 23 detects the presence of an object for each beat frequency by detecting the beat frequencies having a peak value (for example, the peak value of the received intensity or the amplitude) of complex data pieces greater than a predetermined numerical value in each of the ascending portion and the descending portion of a triangular wave based on the information input from the frequency decomposing unit 22, and selects the detected beat frequency corresponding to the object as a target frequency. The peak detecting unit 23 outputs the detection result (the beat frequency as the target frequency and the peak value thereof) of the target frequency to the peak combining unit 24.

The peak detecting unit 23 can detect the beat frequency corresponding to each peak value in the frequency spectrum as a target frequency, for example, based on a frequency spectrum transformed from any of the receiving antennas 1-0 to 1-n, a frequency spectrum transformed from the sum of complex data pieces of all the receiving antennas 1-0 to 1-n, or the like. When the sum of the complex data pieces of all the receiving antennas 1-0 to 1-n is used, it is expected to average noise components and thus to improve an S/N (Signal-to-Noise) ratio.

The peak combining unit 24 combines the beat frequency in each of the ascending portion and the descending portion and the peak value thereof, which are included in the information (the beat frequency as the target frequency and the peak value thereof) input from the peak detecting unit 23, in a matrix shape in a round-robin manner, combines all the beat frequencies in the ascending portions and the descending portions, and sequentially outputs the combination result to the distance detecting unit 25 and the velocity detecting unit 26.

The distance detecting unit 25 calculates a distance r to an object based on the sum of the beat frequencies (the target frequencies) in the combinations of the ascending portion and the descending portion sequentially input from the peak combining unit 24, and outputs the result (which includes the peak values in this example) to the pair fixing unit 27.

The distance r is expressed by Expression 1.

r=[C·T/(2·Δf)]·[(fu+fd)/2] (1)

Here, C represents the light speed, T represents the modulation time (of the ascending portion or the descending portion), and Δf represents the frequency modulation width of a triangular wave. In addition, fu represents the target frequency of the ascending portion of the triangular wave output from the peak combining unit 24 and fd represents the target frequency of the descending portion of the triangular wave output from the peak combining unit 24.

The velocity detecting unit 26 calculates a relative velocity v to the object based on the difference value of the beat frequencies (target frequencies) between the combinations of the ascending portion and the descending portion sequentially input from the peak combining unit 24, and outputs the result (which includes the peak values in this example) to the pair fixing unit 27.

The relative velocity v is expressed by Expression 2.

v=[C/(2·f0)]·[(fu·fd)/2] (2)

Here, f0 represents the central frequency of the triangular wave.

The pair fixing unit 27 determines an appropriate combination of the peaks in the ascending portion and the descending portion corresponding to each object based on the information input from the distance detecting unit 25 and the information input from the velocity detecting unit 26, fixes a pair of peaks in the ascending portion and the descending portion, and outputs a target group number representing the fixed pair (the distance r, the relative velocity v, and the frequency point) to the frequency decomposing unit 22.

Here, since the orientation of each target group is not determined, the position in the transverse direction parallel to the arrangement direction of the receiving antennas 1-0 to 1-n with respect to the axis perpendicular to the arrangement direction of the receiving antenna array in the on-board radar apparatus according to this embodiment is not determined.

The correlation matrix calculating unit 28 calculates a predetermined correlation matrix based on the information input from the frequency decomposing unit 22, and outputs the result to the eigenvalue calculating unit 29.

The eigenvalue calculating unit 29 calculates an eigenvalue based on the information input from the correlation matrix calculating unit 28 and outputs the result to the determination unit 30 and the orientation detecting unit 31.

The determination unit 30 determines the order based on the information input from the eigenvalue calculating unit 29 and outputs the result to the orientation detecting unit 31.

The orientation detecting unit 31 detects and outputs the orientation (orientation angle) of the object based on the information input from the eigenvalue calculating unit 29 or the information input from the determination unit 30.

Here, various methods including known methods may be used as a method (for example, algorithm) used for the orientation detecting unit 31 to detect the orientation of an object.

Specifically, the orientation detecting unit 31 can perform a spectrum estimating process using a spectrum estimating method such as an AR spectrum estimating method as a high-resolution algorithm, a MUSIC (Multiple Signal Classification) method, or a modified covariance (MCOV) method, and can detect (calculate) the orientation of an object based on the spectrum estimating process result. The modified covariance method (MCOV method) is used in this embodiment.

The constituent (the constituent that calculates the correlation matrix, the eigenvalue, and the order and detects the orientation of an object in this example) corresponding to the correlation matrix calculating unit 28, the eigenvalue calculating unit 29, the determination unit 30, or the orientation detecting unit 31 employs the configuration or operation corresponding to the orientation detecting method used in the signal processing unit 20, and may employ configurations or operations other than in this embodiment.

For example, a DBF method may be used as the orientation detecting method performed by the orientation detecting unit 31.

The known technique disclosed in Japanese Unexamined Patent Application, First Publication No. 2011-163883 or the like can be used as the principle of detecting the distance, the relative velocity, and the orientation (orientation angle) for an object.

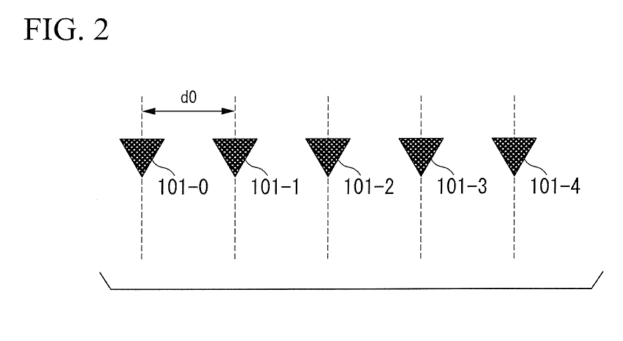

The process performed by the antenna extension unit 51 will be described referring to FIGS. 2 to 5.

FIG. 2 is a block diagram illustrating an example of an arrangement of receiving antennas constituting a receiving antenna array according to an embodiment of the present invention.

In this embodiment, a regular-interval antenna array (regular-pitch antenna array) in which multiple receiving antennas 101-0 to 101-4 (five antennas in this embodiment) are arranged at equal intervals (regular intervals) d0 is used as the receiving antenna array.

Here, the receiving antennas 101-0 to 101-4 shown in FIG. 2 correspond to a case where n=4 is set in the receiving antennas 1-0 to 1-n shown in FIG. 1.

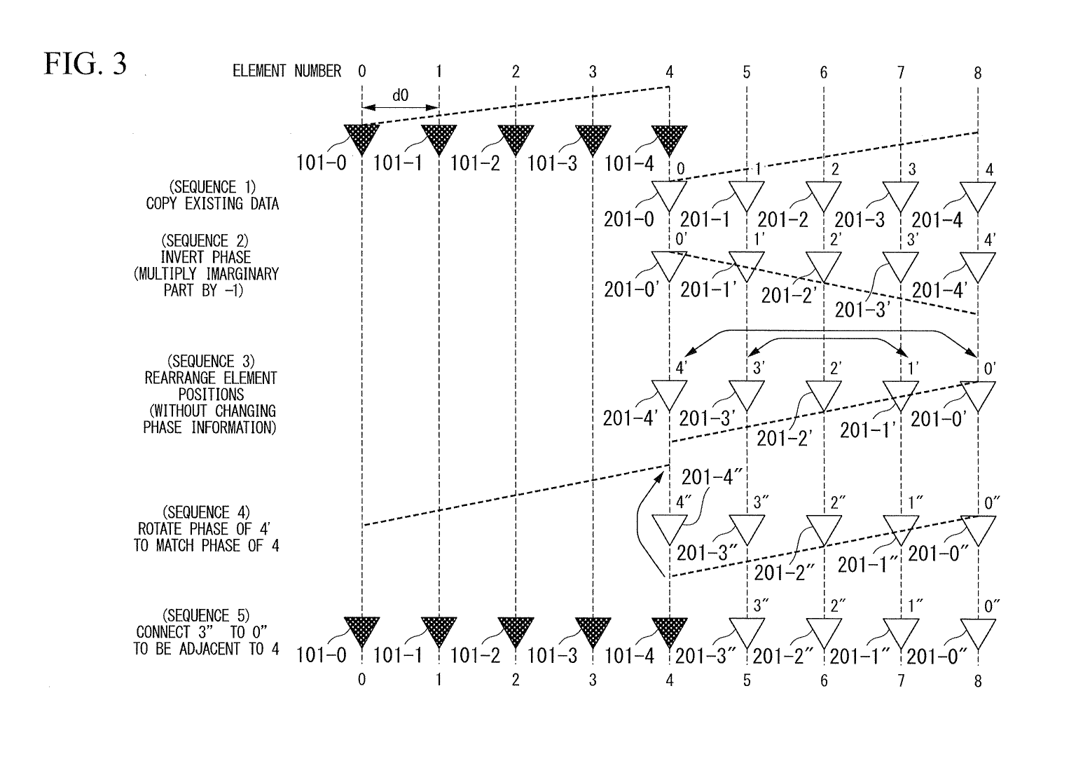

FIG. 3 is a diagram illustrating a sequence of processes performed by the antenna extension unit 51 according to an embodiment of the present invention. FIG. 3 shows a case where the number of existing antennas (the number of receiving antennas) is five.

Schematically, in the radar apparatus shown in FIG. 1, beat signals are generated by receiving reflected waves from a reflecting object (object) by the use of the receiving antenna array and mixing the received reflected waves by the use of the mixers 2-0 to 2-n, the beat signals are converted into digital signals by the A/D converter 5 and are input to the memory 21, and then an FFT process is performed on the digital signals (beat signals) by the frequency decomposing unit 22, thereby obtaining the amplitude information and the phase information of the frequency components. Then, the antenna extension unit 51 performs the processes of sequence 1 to sequence 5 on the amplitude information and the phase information (existing data) of the frequency components obtained in this manner and expressed by complex numbers to virtually increase the number of antenna elements.

In the processes of sequence 1 to sequence 5 in this embodiment, the antenna elements are extended with the relative phase difference maintained between the elements, on the premise that the phases of the elements to be extended are rotated by the orientation (the phase corresponding to the orientation of a target) with respect to the antenna received data pieces of (n+1) elements physically received in the existing method.

Specifically, the antenna extension unit 51 performs the following processes of sequence 1 to sequence 5 as an element extending process of the regular-interval antenna array.

Any memory may be used as the memory used in this process, or for example, the memory disposed in the frequency decomposing unit 22 or the antenna extension unit 51 therein may be used or another memory such as the memory 21 may be used.

In FIG. 3, an image of a wave surface (phase plane) is expressed by a dotted line.

In the process of sequence 1, the antenna extension unit 51 copies existing data (the amplitude information and the phase information of the frequency components) of the receiving antennas 101-0 to 101-4 stored in the memory and stores the copied data in the memory.

In the example shown in FIG. 3, the data pieces (existing data pieces) of the existing five receiving antennas 101-0 to 101-4 are stored as data pieces of element numbers 0 to 4. In this state, the antenna extension unit 51 copies the data pieces (existing data pieces) of the receiving antennas 101-0 to 101-4 of the five element numbers 0 to 4 and store the copied data pieces as element numbers 4 to 8.

In FIG. 3, an image of the copy result is shown as receiving antennas 201-0 to 201-4 of element numbers 4 to 8.

In the process of sequence 2, the antenna extension unit 51 multiplies the imaginary parts of the copied data pieces by −1 to invert the phases.

In the example shown in FIG. 3, the wave surfaces of the data pieces of element numbers 4 to 8 which are the copied data pieces are inverted through this inversion of phase.

In FIG. 3, an image of the phase inversion result is shown as receiving antennas 201-0′ to 201-4′ of element numbers 4 to 8.

In the process of sequence 3, the antenna extension unit 51 rearranges the positions (the arrangement of the receiving antennas 201-0′ to 201-4′) of the elements of the data pieces having the phase inverted without changing the phase information of the data pieces having the phase inverted so that the angles of the wave surfaces of the data pieces having the phase inverted match the angles of the wave surfaces before the phase inversion.

In the example shown in FIG. 3, the antenna extension unit 51 interchanges the element position of the receiving antenna 201-0′ with the element position of the receiving antenna 201-4′ and interchanges the element position of the receiving antenna 201-1′ with the element position of the receiving antenna 201-3′. Accordingly, after the interchange, the receiving antennas are arranged in the order of the receiving antenna 201-4′ to the receiving antenna 201-0′ to respectively correspond to element numbers 4 to 8.

In the process of sequence 4, the antenna extension unit 51 rotates the phases of all the copied data pieces (the data pieces of the receiving antenna 201-4′ to the receiving antenna 201-0′) so that the phases of two data pieces (the data pieces of the receiving antenna 101-4 and the receiving antenna 201-4′) overlapping at element number 4 match each other.

In the example shown in FIG. 3, the antenna extension unit 51 rotates the phases of the data pieces of the receiving antenna 201-4′ to the receiving antenna 201-0′ of element numbers 4 to 8 by the same amount so that the phases of the data piece of the receiving antenna 201-4′ match the phase of the data piece of the receiving antenna 101-4.

In FIG. 3, an image of the result of the phase rotation is shown as a receiving antenna 201-4″ to a receiving antenna 201-0″ of element numbers 4 to 8.

In the process of sequence 5, the antenna extension unit 51 connects all the data pieces of element numbers 0 to 8 by connecting the data pieces of the extended elements (element numbers 5 to 8) to element number 4 using the existing data piece (the data piece of the receiving antenna 101-4) for the position of element number 4 at which two data pieces overlap without using the copied data piece (the data piece of the receiving antenna 101-4″).

In the example shown in FIG. 3, the antenna extension unit 51 connects the data pieces of the receiving antennas 201-3″ to 201-0″ obtained through the process of sequence 4 at extended element numbers 5 to 8 to the data pieces of the existing receiving antennas 101-0 to 101-4 at element numbers 0 to 4. Accordingly, reception signals are virtually obtained through the use of the receiving antenna array including nine elements (receiving antennas) of element numbers 0 to 8.

In this manner, the antenna extension unit 51 acquires the data pieces (the amplitude information and the phase information of the frequency components in this embodiment) of the elements when the number of elements increases, and allows, for example, the extended data pieces (or the result thereof) to be used in the subsequent processes. In this embodiment, the extended data pieces (or the result thereof) are used in the processing units subsequent to the frequency decomposing unit 22.

Specifically, for example, the orientation detecting process in the orientation detecting unit 31 can be performed using the data pieces (or the result thereof) obtained by extending the elements of the existing antennas. For example, the distance detecting process in the distance detecting unit 25 or the velocity detecting process in the velocity detecting unit 26 can also be performed using the data pieces (or the result thereof) obtained by extending the elements of the existing antennas.

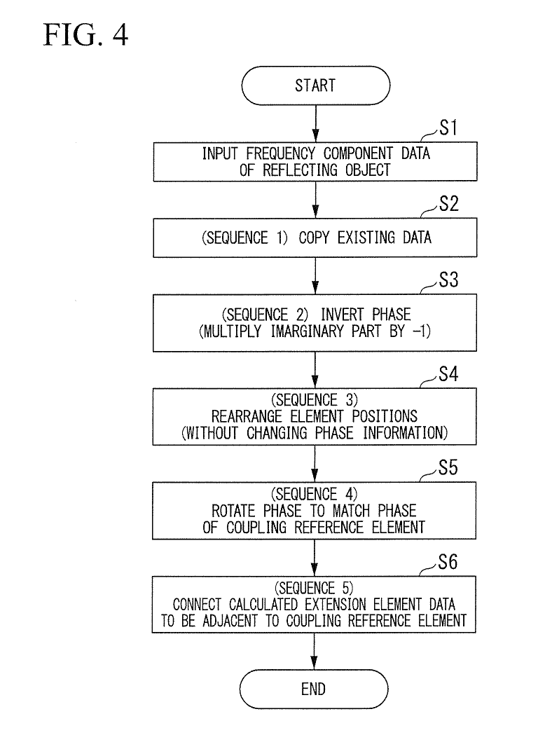

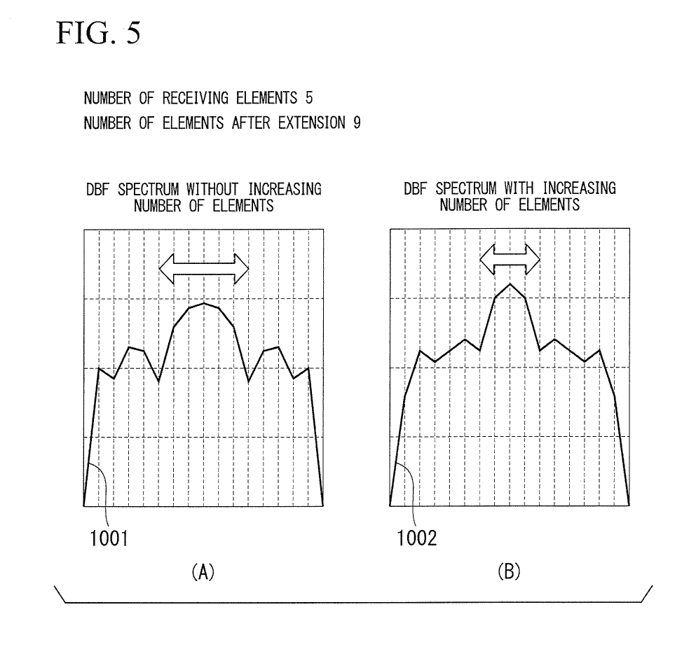

FIG. 4 is a flowchart illustrating an example of the sequence of processes which is performed by the antenna extension unit 51 according to an embodiment of the present invention.

First, the antenna extension unit 51 receives data of frequency components of a reflecting object (object) (step S1).

Then, the antenna extension unit 51 copies the existing data through the process of sequence 1 (step S2).

Then, the antenna extension unit 51 inverts the phase by multiplying the imaginary part of the copied data by −1 through the process of sequence 2 (step S3).

Subsequently, the antenna extension unit 51 rearranges the element positions without changing the phase information of the data having the phase inverted through the process of sequence 3 (step S4).

Then, the antenna extension unit 51 rotates the phase of the data having the element positions rearranged so as to match the phase of an element (the element of element number 4 in the example shown in FIG. 3) serving as a reference for coupling through the process of sequence 4 (step S5).

Then, the antenna extension unit 51 connects the data of the calculated extended elements (the elements of element numbers 5 to 8 in the example shown in FIG. 3) to the element (the element of element number 4 in the example shown in FIG. 3) serving as a reference for coupling through the process of sequence 5 (step S6).

Part (A) of FIG. 5 is a diagram illustrating an example of the result of a simulation of a DBF spectrum when the number of elements does not increase. A DBF spectrum 1001 is shown in the graph.

Part (B) of FIG. 5 is a diagram illustrating an example of a simulation of a DBF spectrum when the number of elements increases. A DBF spectrum 1002 is shown in the drawing.

In the simulations of Part (A) and Part (B) of FIG. 5, the number of physical elements (receiving antennas) is five. Part (A) of FIG. 5 shows a DBF spectrum 1001 obtained when the number of elements does not extend (increase), and Part (B) of FIG. 5 shows a DBF spectrum 1002 obtained when the number of elements virtually extends (increases) up to nine elements, as shown in the example of FIG. 3.

The beam of the DBF spectrum 1002 shown in Part (B) of FIG. 5 is narrower than the beam of the DBF spectrum 1001 shown in Part (A) of FIG. 5 and thus the resolution in the transverse direction thereof is superior.

As described above, in the antenna extension unit 51 of the on-board radar apparatus according to this embodiment, elements can be virtually extended to the outside from the data received by the existing antenna elements by performing the processes such as phase inversion, rearrangement of element positions, and phase rotation based on the data received by the existing antenna elements (receiving antennas) through the use of the processes of sequence 1 to sequence 5 shown in FIGS. 3 and 4. Accordingly, it is possible to improve performance (for example, resolution). In this manner, in the antenna extension unit 51 of the on-board radar apparatus according to this embodiment, it is possible to effectively improve the resolution of the signals received through the use of the receiving antenna array.

Accordingly, in this embodiment, it is possible to process, for example, information which has not been treated in the processes of the related art.

In the related art, there is a problem in that a received beam is dispersed in the DBF or the like to deteriorate the resolution in the transverse direction when the number of elements is small, or there is a problem in that the number of arrival waves which can be treated by a spectrum estimating method such as the MCOV method or the MUSIC method is restricted. However, in this embodiment, it is possible to estimate more components (for example, all the components) of arrival waves included in the signals received, for example, by the existing antenna elements.

Accordingly, in this embodiment, it is possible to treat more arrival wave signals than in the existing regular-interval antenna array.

In this embodiment, it is possible to increase the number of arrival waves (the number of reception signals), for example, without physically increasing the number of elements (receiving antennas) of the receiving antenna array or without increasing the apparent number of received data pieces (the apparent number of elements of the receiving antenna array) by switching transmission and reception multiple times instead of physically increasing the number of elements of the receiving antenna array.

In this embodiment, it is possible to improve the resolution, by virtually extrapolating the elements (receiving antennas) based on the data received through the use of the existing receiving antenna array instead of interpolating the elements (receiving antennas) of the existing receiving antenna array.

In case of the regular-interval antenna array, a method (for example, a method described in the second embodiment) of extending the virtual elements, for example, only by rotating the phase can be used. However, in this embodiment, by rotating the phases and connecting the extended elements so that the phases of two data pieces in the same element (the element of element number 4 in the example shown in FIG. 3) match each other through the use of the processes of sequence 1 to sequence 5 shown in FIGS. 3 and 4, it is possible to suppress discordance (for example, a phase discordance) to be small (for example, to be a minimum).

### Second Embodiment

In this embodiment, another example of the element extending process in a regular-interval antenna array which is different from the element extending process in the regular-interval antenna array according to the first embodiment shown in FIG. 3 will be described.

In this embodiment, the schematic configuration of the on-board radar apparatus shown in FIG. 1 or the arrangement of the receiving antennas constituting the receiving antenna array shown in FIG. 2 are the same as described in the first embodiment and the same reference numerals will be used for description thereof.

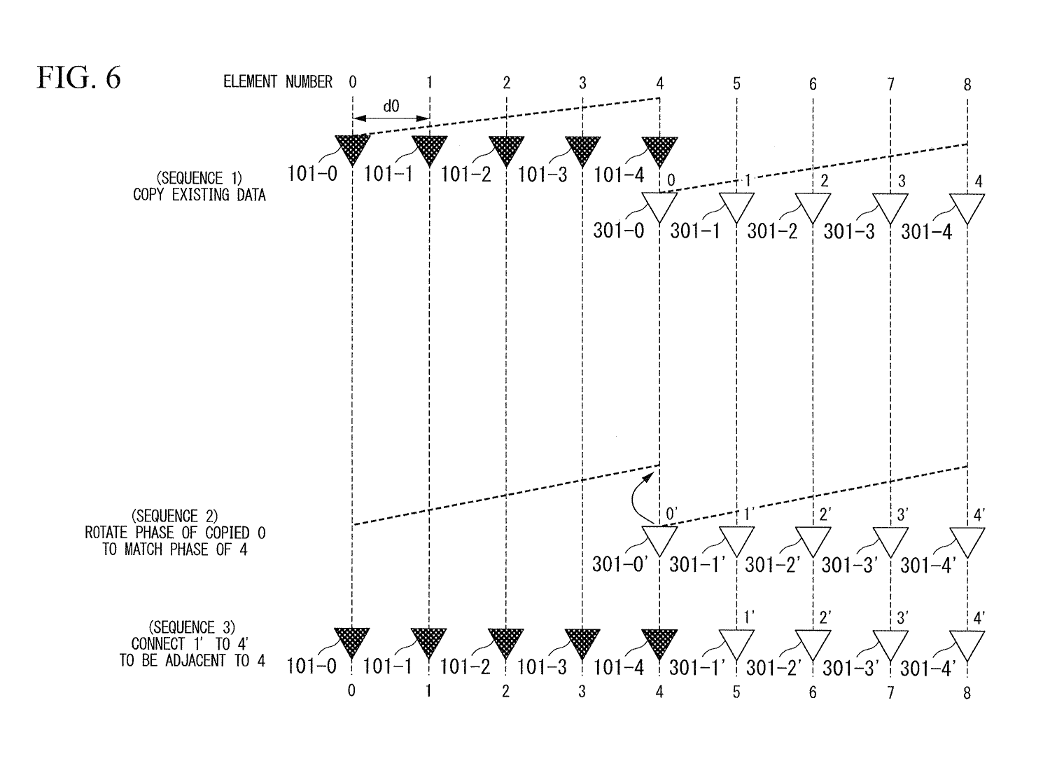

FIG. 6 is a diagram illustrating a sequence of processes performed by the antenna extension unit 51 according to an embodiment of the present invention. FIG. 6 shows a case where the number of existing antennas (the number of receiving antennas) is five.

Schematically, in the radar apparatus shown in FIG. 1, beat signals are generated by receiving reflected waves from a reflecting object (object) by the use of the receiving antenna array and mixing the received reflected waves by the use of the mixers 2-0 to 2-n, the beat signals are converted into digital signals by the A/D converter 5 and are input to the memory 21, and then an FFT process is performed on the digital signals (beat signals) by the frequency decomposing unit 22, thereby obtaining the amplitude information and the phase information of the frequency components. Then, the antenna extension unit 51 performs the processes of sequence 1 to sequence 3 on the amplitude information and the phase information (existing data) of the frequency components obtained in this manner and expressed by complex numbers to virtually increase the number of antenna elements.

In the processes of sequence 1 to sequence 3 in this embodiment, the antenna elements are extended with the relative phase difference maintained between the elements, on the premise that the phases of the elements to be extended are rotated by the orientation (the phase corresponding to the orientation of a target) with respect to the antenna received data pieces of (n+1) elements physically received in the existing method.

Specifically, the antenna extension unit 51 performs the following processes of sequence 1 to sequence 3 as an element extending process of the regular-interval antenna array.

Any memory may be used as the memory used in this process, or for example, the memory disposed in the frequency decomposing unit 22 or the antenna extension unit 51 therein may be used or another memory such as the memory 21 may be used.

In FIG. 6, an image of a wave surface (phase plane) is expressed by a dotted line.

In the process of sequence 1, the antenna extension unit 51 copies existing data (the amplitude information and the phase information of the frequency components in this embodiment) of the receiving antennas 101-0 to 101-4 stored in the memory and stores the copied data in the memory.

In the example shown in FIG. 6, the data pieces (existing data pieces) of the existing five receiving antennas 101-0 to 101-4 are stored as data pieces of element numbers 0 to 4. In this state, the antenna extension unit 51 copies the data pieces (existing data pieces) of the receiving antennas 101-0 to 101-4 of the five element numbers 0 to 4 and store the copied data pieces as element numbers 4 to 8, respectively.

In FIG. 6, an image of the copy result is shown as receiving antennas 301-0 to 301-4 of element numbers 4 to 8.

In the process of sequence 2, the antenna extension unit 51 rotates the phases of all the copied data pieces (the data pieces of the receiving antenna 301-0 to the receiving antenna 301-4) so that the phases of two data pieces (the data pieces of the receiving antenna 101-4 and the receiving antenna 301-0) overlapping at element number 4 match each other.

In the example shown in FIG. 6, the antenna extension unit 51 rotates the phases of the data pieces of the receiving antenna 301-0 to the receiving antenna 301-4 of element numbers 4 to 8 by the same amount so that the phases of the data piece of the receiving antenna 301-0 match the phase of the data piece of the receiving antenna 101-4.

In FIG. 6, an image of the result of the phase rotation is shown as a receiving antenna 301-0′ to a receiving antenna 301-4′ of element numbers 4 to 8.

In the process of sequence 3, the antenna extension unit 51 connects all the data pieces of element numbers 0 to 8 by connecting the data pieces of the extended elements (element numbers 5 to 8) to element number 4 using the existing data piece (the data piece of the receiving antenna 101-4) for the position of element number 4 at which two data pieces overlap without using the copied data piece (the data piece of the receiving antenna 301-0′).

In the example shown in FIG. 6, the antenna extension unit 51 connects the data pieces of the receiving antennas 301-1′ to 301-4′ obtained through the process of sequence 2 at extended element numbers 5 to 8 to the data pieces of the existing receiving antennas 101-0 to 101-4 at element numbers 0 to 4. Accordingly, reception signals are virtually obtained through the use of the receiving antenna array including nine elements (receiving antennas) of element numbers 0 to 8.

In this manner, the antenna extension unit 51 acquires the data pieces (the amplitude information and the phase information of the frequency components in this embodiment) of the elements when the number of elements increases, and allows, for example, the extended data pieces (or the result thereof) to be used in the subsequent processes. In this embodiment, the extended data pieces (or the result thereof) are used in the processing units subsequent to the frequency decomposing unit 22.

Specifically, for example, the orientation detecting process in the orientation detecting unit 31 can be performed using the data pieces (or the result thereof) obtained by extending the elements of the existing antennas. For example, the distance detecting process in the distance detecting unit 25 or the velocity detecting process in the velocity detecting unit 26 can also be performed using the data pieces (or the result thereof) obtained by extending the elements of the existing antennas.

As described above, in the antenna extension unit 51 of the on-board radar apparatus according to this embodiment, elements can be virtually extended to the outside from the data received by the existing antenna elements by performing the processes such as phase rotation based on the data received by the existing antenna elements (receiving antennas) through the use of the processes of sequence 1 to sequence 3 shown in FIG. 6. Accordingly, it is possible to improve performance (for example, resolution). In this manner, in the antenna extension unit 51 of the on-board radar apparatus according to this embodiment, it is possible to effectively improve the resolution of the signals received through the use of the receiving antenna array.

Accordingly, in this embodiment, it is possible to process, for example, information which has not been treated in the processes of the related art.

In the related art, there is a problem in that a received beam is dispersed in the DBF or the like to deteriorate the resolution in the transverse direction when the number of elements is small, or there is a problem in that the number of arrival waves which can be treated by a spectrum estimating method such as the MCOV method or the MUSIC method is restricted. However, in this embodiment, it is possible to estimate more components (for example, all the components) of arrival waves included in the signals received, for example, by the existing antenna elements.

Accordingly, in this embodiment, it is possible to treat more arrival wave signals than in the existing regular-interval antenna array.

In this embodiment, it is possible to increase the number of arrival waves (the number of reception signals), for example, without physically increasing the number of elements (receiving antennas) of the receiving antenna array or without increasing the apparent number of received data pieces (the apparent number of elements of the receiving antenna array) by switching transmission and reception multiple times instead of physically increasing the number of elements of the receiving antenna array.

In this embodiment, it is possible to improve the resolution, by virtually extrapolating the elements (receiving antennas) based on the data received through the use of the existing receiving antenna array instead of interpolating the elements (receiving antennas) of the existing receiving antenna array.

In the element extending process of the regular-interval antenna array according to this embodiment shown in FIG. 6, it is possible to realize the extension of virtual elements with a simpler sequence of processes, for example, compared with the element extending process of the regular-interval antenna array according to the first embodiment shown in FIG. 3.

### Another Description of Embodiments

New configuration examples of the element extending process of the regular-interval antenna array according to the first embodiment shown in FIG. 3 and the element extending process of the regular-interval antenna array according to the second embodiment shown in FIG. 6 will be described below.

For example, in the example shown in FIG. 3 and the example shown in FIG. 6, the configuration example where data pieces obtained by copying the existing data pieces are added to the data piece having a larger element number (the data piece on the right side in the example shown in FIG. 3 and the example shown in FIG. 6) to extend the data pieces is shown. In another configuration example, data pieces obtained by copying the existing data pieces may be added to the data piece having a smaller element number (the data piece on the left side in the example shown in FIG. 3 and the example shown in FIG. 6) to extend the data pieces. They are opposite only in the direction in which the elements are extended, but employ the same processes (processes corresponding to the opposite direction in which the elements are extended).

For example, in the example shown in FIG. 3 and the example shown in FIG. 6, all the existing elements (the receiving antennas 101-0 to 101-4) are copied to extend the data pieces. In another configuration example, only some (two or more continuous elements at any position) continuous elements located at any position in the existing elements may be copied to extend the data pieces.

For example, in the example shown in FIG. 3 and the example shown in FIG. 6, the configuration example where the data pieces obtained by copied the existing data pieces are added only once to extend the data pieces is described. In another configuration example, the data pieces obtained by copying the existing data pieces may be added multiple times to extend the data pieces.

In another configuration example, so as to be added to the configuration in which the element extending process using the same element extending method is performed multiple times, multiple element extending processes using different element extending methods (for example, different in the number of elements to be extended or different in the existing elements to be used to extend the elements or the extending direction) may be performed in combination.

For example, in the example shown in FIG. 3 and the example shown in FIG. 6, the case in which the number of elements actually present (the number of receiving antennas) corresponding to the existing elements is five is described. However, the number of elements actually present may be set to two or more.

The number of elements to be virtually extended from the number of elements actually present (or the same is substantially true of the total number of elements after the virtual extension) may be set to various numbers.

It is preferable that these processes be performed so as not to change the phase difference between the two or more continuous elements used to extend the elements.

For example, when a receiving antenna array (irregular-interval antenna array) having two or more different intervals (antenna intervals) is used, the element extending process of the regular-interval antenna array according to the first embodiment shown in FIG. 3 or the element extending process of the regular-interval antenna array according to the second embodiment shown in FIG. 6 may be performed on a portion (portion which can be considered as a regular-interval antenna array) in which two or more receiving antennas are arranged at regular intervals out of the multiple receiving antennas constituting the receiving antenna array.

In the above-mentioned embodiments, the function of the antenna extension unit 51 is provided to the frequency decomposing unit 22 of the radar apparatus shown in FIG. 1. In another configuration example, the function of the antenna extension unit 51 may be provided to the orientation detecting unit 31 or the function of the antenna extension unit 51 may be provided to another unit.

When the function of the antenna extension unit 51 is provided to the orientation detecting unit 31 or the like, for example, the data pieces (the amplitude information and the phase information of the frequency components in this embodiment) on the existing receiving antennas (the existing receiving antennas 101-0 to 101-4 in the example shown in FIG. 3 and the example shown in FIG. 6) may be output to the orientation detecting unit 31 or the like from the frequency decomposing unit 22 directly or indirectly, and the antenna extension unit 51 disposed in the orientation detecting unit 31 or the like may perform the element extending process using the data pieces input to the orientation detecting unit 31 or the like.

The element extending process may be performed at the time of performing the processes such as orientation detection, or the element extending process may be performed in advance before performing the processes of orientation detection, the resultant data of the element extending process may be stored in the memory, and the resultant data of the element extending process may be read from the memory at the time of performing the processes such as orientation detection and may be used for the processes such as orientation detection.

In the above-mentioned embodiments, the present invention is applied to the on-board radar apparatus or the millimeter wave radar, but is not limited to the radar apparatuses. The present invention may be applied to other apparatuses.

In the above-mentioned embodiments, the present invention is applied to the apparatus that detect information (information such as orientation) on the position of an object, but is not limited to such an apparatus. The present invention may be applied to other apparatuses.

Configurations according to Embodiments

### (Configuration 1) Configuration Corresponding to Processes According to First Embodiment Shown in FIG. 3

A receiving and processing device (for example, the on-board radar apparatus shown in FIG. 1), which processes data pieces of a plurality of receiving antennas 101-0 to 101-4 acquired based on signals received by the receiving antennas 101-0 to 101-4 constituting a receiving antenna array in which the plurality of receiving antennas 101-0 to 101-4 are arranged at regular intervals, is provided including an antenna extension unit 51 configured to perform: a process (the process of sequence 1 in the example shown in FIG. 3) of arranging the data pieces of two or more continuous receiving antennas (the receiving antennas 101-0 to 101-4 in the example shown in FIG. 3) of the plurality of receiving antennas 101-0 to 101-4 in such a manner that a position of the receiving antenna (the receiving antenna 101-0 at the left end in the example shown in FIG. 3) at one end of the two or more receiving antennas is located at a position of the receiving antenna (the receiving antenna 101-4 at the right end in the example shown in FIG. 3) at the opposite end of the plurality of receiving antennas 101-0 to 101-4; a process (the process of sequence 2 in the example shown in FIG. 3) of inverting phases of data pieces of the additionally-arranged two or more receiving antennas; a process (the process of sequence 3 in the example shown in FIG. 3) of rearranging the data pieces of the phase-inverted two or more receiving antennas so as to invert the arrangement of the data pieces; a process (the process of sequence 4 in the example shown in FIG. 3) of rotating the phases of the data pieces of the rearranged two or more receiving antennas so that the phases of two data pieces at the position of the receiving antenna (the receiving antenna 101-4 at the right end in the example shown in FIG. 3) at the opposite end of the plurality of receiving antennas 101-0 to 101-4 match each other; and a process (the process of sequence 5 in the example shown in FIG. 3) of connecting the data pieces of the phase-rotated two or more receiving antennas to the data pieces of the plurality of receiving antennas 101-0 to 101-4 by employing the data piece of the corresponding receiving antenna at the position of the receiving antenna (the receiving antenna 101-4 at the right end in the example shown in FIG. 3) at the opposite end of the plurality of receiving antennas 101-0 to 101-4.

Here, the number of receiving antennas constituting the receiving antenna array may be set to various numbers.

The interval (regular interval) at which the receiving antennas constituting the receiving antenna array are arranged (for example, in a straight line) may be set to various intervals.

The two or more continuous receiving antennas out of the plurality of receiving antennas may be set to various receiving antennas.

### (Configuration 2) Configuration Corresponding to Processes According to Second Embodiment Shown in FIG. 6

A receiving and processing device (for example, the on-board radar apparatus shown in FIG. 1), which processes data pieces of a plurality of receiving antennas 101-0 to 101-4 acquired based on signals received by the receiving antennas 101-0 to 101-4 constituting a receiving antenna array in which the plurality of receiving antennas 101-0 to 101-4 are arranged at regular intervals, is provided including an antenna extension unit 51 configured to perform: a process (the process of sequence 1 in the example shown in FIG. 6) of arranging the data pieces of two or more continuous receiving antennas (the receiving antennas 101-0 to 101-4 in the example shown in FIG. 6) of the plurality of receiving antennas 101-0 to 101-4 so as to be added to the data pieces of the plurality of receiving antennas 101-0 to 101-4 in such a manner that a position of the receiving antenna (the receiving antenna 101-0 at the left end in the example shown in FIG. 6) at one end of the two or more receiving antennas is located at a position of the receiving antenna (the receiving antenna 101-4 at the right end in the example shown in FIG. 6) at the opposite end of the plurality of receiving antennas 101-0 to 101-4; a process (the process of sequence 2 in the example shown in FIG. 6) of rotating the phases of the data pieces of the rearranged two or more receiving antennas so that the phases of two data pieces at the position of the receiving antenna (the receiving antenna 101-4 at the right end in the example shown in FIG. 6) at the opposite end of the plurality of receiving antennas 101-0 to 101-4 match each other; and a process (the process of sequence 3 in the example shown in FIG. 6) of connecting the data pieces of the phase-rotated two or more receiving antennas to the data pieces of the plurality of receiving antennas 101-0 to 101-4 by employing the data piece of the corresponding receiving antenna at the position of the receiving antenna (the receiving antenna 101-4 at the right end in the example shown in FIG. 6) at the opposite end of the plurality of receiving antennas 101-0 to 101-4.

Here, the number of receiving antennas constituting the receiving antenna array may be set to various numbers.

The interval (regular interval) at which the receiving antennas constituting the receiving antenna array are arranged (for example, in a straight line) may be set to various intervals.

The two or more continuous receiving antennas out of the plurality of receiving antennas may be set to various receiving antennas.

(Configuration 3) Example shown in FIG. 3 and Example shown in FIG. 6

In the receiving and processing device according to Configuration 1 or Configuration 2, the two or more continuous receiving antennas of the plurality of receiving antennas 101-0 to 101-4 may include all the plurality of receiving antennas 101-0 to 101-4.

(Configuration 4) Example shown in FIG. 1

In the receiving and processing device according to any one of Configuration 1 to Configuration 3, the receiving and processing device may be mounted on an on-board radar apparatus, a received wave arriving by causing an object to reflect a transmitted wave may be received through the use of the receiving antenna array, the data pieces of the receiving antennas 101-0 to 101-4 may be complex data of frequency components, and information (for example, information on the orientation) on the position of the object may be detected using the data pieces acquired by the antenna extension unit.

### Summary of the Above Embodiments

As described above, the embodiments of the invention have been described in detail with reference to the accompanying drawings, but a specific configuration is not limited to the above description, and various design changes may be made in a range without departing from the spirit of the invention.

Moreover, the processing may be performed by recording (storing) a program for performing the functions of the radar apparatus according to the above embodiments (for example, the function of the antenna extension unit 51) in a computer-readable recording medium (storage medium) and by causing a computer system to read and execute the program recorded in the recording medium. Here, the “computer system” includes an OS (operation system) or hardware such as peripherals.

Examples of the “computer-readable recording medium” include portable mediums such as a flexible disk, a magneto-optical disc, a ROM (Read Only Memory) or a flash memory, a movable medium such as a DVD (Digital Versatile Disk), or a hard disk built in the computer system.

Furthermore, the “computer-readable recording medium” may include a recording medium dynamically storing a program for a short time like a transmission medium when the program is transmitted via a network such as the Internet or a communication line such as a phone line and a recording medium storing a program for a predetermined time like a volatile memory (RAM) in a computer system serving as a server or a client in that case.

The programs may be transmitted from a computer system having the programs stored in a storage device thereof or the like to another computer system through a transmission medium or by carrier waves in the transmission medium. The “transmission medium” which transmits a program means a medium having a function of transmitting information and examples thereof include a network (communication network) such as the Internet and a communication link (communication line) such as a telephone line.

The program may realize some of the above-described functions. The program may realize the above-described functions in combination with a program already recorded in a computer system, that is, the program may be a differential file (differential program).

What is claimed is:

1. A receiving and processing device processing data pieces of a plurality of receiving antennas acquired based on signals received by the receiving antennas constituting a receiving antenna array in which the plurality of receiving antennas are arranged at regular intervals, the device comprising an antenna extension unit configured to perform:
a process of arranging the data pieces of two or more continuous receiving antennas of the plurality of receiving antennas so as to be added to the data pieces of the plurality of receiving antennas in such a manner that a position of the receiving antenna at one end of the two or more receiving antennas is located at a position of the receiving antenna at the opposite end of the plurality of receiving antennas;
a process of inverting phases of data pieces of the additionally-arranged two or more receiving antennas;
a process of rearranging the data pieces of the phase-inverted two or more receiving antennas so as to invert the arrangement of the data pieces;
a process of rotating the phases of the data pieces of the rearranged two or more receiving antennas so that the phases of two data pieces at the position of the receiving antenna at the opposite end of the plurality of receiving antennas match each other; and
a process of connecting the data pieces of the phase-rotated two or more receiving antennas to the data pieces of the plurality of receiving antennas by employing the data piece of the corresponding receiving antenna at the position of the receiving antenna at the opposite end of the plurality of receiving antennas.

2. A receiving and processing device processing data pieces of a plurality of receiving antennas acquired based on signals received by the receiving antennas constituting a receiving antenna array in which the plurality of receiving antennas are arranged at regular intervals, the device comprising an antenna extension unit configured to perform:
a process of arranging the data pieces of two or more continuous receiving antennas of the plurality of receiving antennas so as to be added to the data pieces of the plurality of receiving antennas in such a manner that a position of the receiving antenna at one end of the two or more receiving antennas is located at a position of the receiving antenna at the opposite end of the plurality of receiving antennas;
a process of rotating the phases of the data pieces of the additionally-arranged two or more receiving antennas so that the phases of two data pieces at the position of the receiving antenna at the opposite end of the plurality of receiving antennas match each other; and
a process of connecting the data pieces of the phase-rotated two or more receiving antennas to the data pieces of the plurality of receiving antennas by employing the data piece of the corresponding receiving antenna at the position of the receiving antenna at the opposite end of the plurality of receiving antennas.

3. The receiving and processing device according to claim 1, wherein the two or more continuous receiving antennas of the plurality of receiving antennas include all the plurality of receiving antennas.

4. The receiving and processing device according to claim 2, wherein the two or more continuous receiving antennas of the plurality of receiving antennas include all the plurality of receiving antennas.

5. The receiving and processing device according to claim 1, wherein the receiving and processing device is mounted on an on-board radar apparatus,
wherein a received wave arriving by causing an object to reflect a transmitted wave is received through the use of the receiving antenna array,
wherein the data pieces of the receiving antennas are complex data of frequency components, and
wherein information on the position of the object is detected using the data pieces acquired by the antenna extension unit.

6. The receiving and processing device according to claim 2, wherein the receiving and processing device is mounted on an on-board radar apparatus,
wherein a received wave arriving by causing an object to reflect a transmitted wave is received through the use of the receiving antenna array,
wherein the data pieces of the receiving antennas are complex data of frequency components, and
wherein information on the position of the object is detected using the data pieces acquired by the antenna extension unit.

7. A receiving and processing method processing data pieces of a plurality of receiving antennas acquired based on signals received by the receiving antennas constituting a receiving antenna array in which the plurality of receiving antennas are arranged at regular intervals, the method comprising the steps of:
arranging the data pieces of two or more continuous receiving antennas of the plurality of receiving antennas so as to be added to the data pieces of the plurality of receiving antennas in such a manner that a position of the receiving antenna at one end of the two or more receiving antennas is located at a position of the receiving antenna at the opposite end of the plurality of receiving antennas;
inverting phases of data pieces of the additionally-arranged two or more receiving antennas;
rearranging the data pieces of the phase-inverted two or more receiving antennas so as to invert the arrangement of the data pieces;
rotating the phases of the data pieces of the rearranged two or more receiving antennas so that the phases of two data pieces at the position of the receiving antenna at the opposite end of the plurality of receiving antennas match each other; and
connecting the data pieces of the phase-rotated two or more receiving antennas to the data pieces of the plurality of receiving antennas by employing the data piece of the corresponding receiving antenna at the position of the receiving antenna at the opposite end of the plurality of receiving antennas.

8. A receiving and processing method processing data pieces of a plurality of receiving antennas acquired based on signals received by the receiving antennas constituting a receiving antenna array in which the plurality of receiving antennas are arranged at regular intervals, the method comprising the steps of:
arranging the data pieces of two or more continuous receiving antennas of the plurality of receiving antennas so as to be added to the data pieces of the plurality of receiving antennas in such a manner that a position of the receiving antenna at one end of the two or more receiving antennas is located at a position of the receiving antenna at the opposite end of the plurality of receiving antennas;
rotating the phases of the data pieces of the additionally-arranged two or more receiving antennas so that the phases of two data pieces at the position of the receiving antenna at the opposite end of the plurality of receiving antennas match each other; and
connecting the data pieces of the phase-rotated two or more receiving antennas to the data pieces of the plurality of receiving antennas by employing the data piece of the corresponding receiving antenna at the position of the receiving antenna at the opposite end of the plurality of receiving antennas.

9. A receiving and processing program processing data pieces of a plurality of receiving antennas acquired based on signals received by the receiving antennas constituting a receiving antenna array in which the plurality of receiving antennas are arranged at regular intervals, the program causing a computer to perform the sequences of:
arranging the data pieces of two or more continuous receiving antennas of the plurality of receiving antennas so as to match a position of the receiving antenna at one end of the two or more receiving antennas with a position of the receiving antenna at the opposite end of the plurality of receiving antennas;
inverting phases of data pieces of the additionally-arranged two or more receiving antennas;
rearranging the data pieces of the phase-inverted two or more receiving antennas so as to invert the arrangement of the data pieces;
rotating the phases of the data pieces of the rearranged two or more receiving antennas so that the phases of two data pieces at the position of the receiving antenna at the opposite end of the plurality of receiving antennas match each other; and
connecting the data pieces of the phase-rotated two or more receiving antennas to the data pieces of the plurality of receiving antennas by employing the data piece of the corresponding receiving antenna at the position of the receiving antenna at the opposite end of the plurality of receiving antennas.

10. A receiving and processing program processing data pieces of a plurality of receiving antennas acquired based on signals received by the receiving antennas constituting a receiving antenna array in which the plurality of receiving antennas are arranged at regular intervals, the program causing a computer to perform the sequences of:
arranging the data pieces of two or more continuous receiving antennas of the plurality of receiving antennas so as to match a position of the receiving antenna at one end of the two or more receiving antennas with a position of the receiving antenna at the opposite end of the plurality of receiving antennas;
rotating the phases of the data pieces of the additionally-arranged two or more receiving antennas so that the phases of two data pieces at the position of the receiving antenna at the opposite end of the plurality of receiving antennas match each other; and
connecting the data pieces of the phase-rotated two or more receiving antennas to the data pieces of the plurality of receiving antennas by employing the data piece of the corresponding receiving antenna at the position of the receiving antenna at the opposite end of the plurality of receiving antennas.
